(19) United States
(12) Patent Application Publication
(10) Pub. No.: US 2025/0291125 A1
(43) Pub. Date: Sep. 18, 2025

(54) COMPACT HYBRID FIBER AND COPPER CONNECTOR WITH LEAF SPRING ADAPTER

(71) Applicant: Panduit Corp., Tinley Park, IL (US)

(72) Inventors: Ryan N. Murphy, Monee, IL (US); Masud Bolouri-Saransar, Orland Park, IL (US); Yu Huang, Orland Park, IL (US); Jose M. Castro, Naperville, IL (US); Thomas M. Sedor, Orland Park, IL (US); Bulent Kose, Burr Ridge, IL (US)

(73) Assignee: Panduit Corp., Tinley Park, IL (US)

(21) Appl. No.: 19/049,291

(22) Filed: Feb. 10, 2025

Related U.S. Application Data
(60) Provisional application No. 63/565,600, filed on Mar. 15, 2024.

(51) Int. Cl. G02B 6/38; H01R 13/05; H01R 31/06

(52) U.S. Cl. CPC G02B 6/3817; G02B 6/3825; H01R 13/055; H01R 31/06

(57) ABSTRACT

A hybrid connector assembly system for providing data communications via both fiber and copper wires while utilizing a compact form factor is provided. The hybrid connector assembly system including a hybrid adapter and two hybrid connectors for respectively installing into opposite ends of the hybrid adapter.

### CROSS-REFERENCE TO RELATED APPLICATION(S)

This application claims benefit to U.S. Provisional Patent Application No. 63/565,600, filed Mar. 15, 2024, the entirety of which is hereby incorporated by reference herein.

### TECHNICAL FIELD

The present disclosure relates to hybrid optical fiber and electrical conductor connector assemblies that utilize electrically conductive components of a fiber optic connector and a leaf spring contact assembled within modified adapter housings.

### BACKGROUND

Datacenter architectures using optical fiber are evolving to meet global traffic demands and the increasing number of users and applications. Fiber to the home (FTTH) networks have become integral to modem telecommunications infrastructure, providing high-speed internet access and multimedia services directly to residences. In these networks, optical fiber is the primary medium for transmitting data due to its exceptional bandwidth and minimal signal loss characteristics. However, one challenge faced in FTTH deployments is the need for simultaneous power distribution to FTTH endpoints to supply electric power to various network elements, such as Optical Network Units (ONUs), Customer Premises Equipment (CPE), or surveillance cameras, alongside data transmission.

Integrating optical fiber and copper within the FTTH environment necessitates efficient and reliable connectivity solutions. Hybrid connectors that enable the coexistence of optical fiber and copper conductors have been developed. However, existing hybrid connectors are bulky and complicated to manufacture. Therefore, it is desirable to develop a compact hybrid connector that may be implemented within the same, or at least substantially similar, form factor of existing fiber optic connectors to be able to retrofit the compact hybrid connectors into existing fiber optic adapters.

### SUMMARY

According to one non-limiting exemplary embodiment of the present disclosure, a hybrid connector including an optical fiber component and an electrical conductor component is provided. This hybrid connector may contain a SC type fiber optic connector and a SC fiber optic adapter, wherein the fiber optic connectors can be connected to each other via the fiber optic adapter, wherein a leaf spring conductor is located inside the fiber optic adapter, wherein an opening on top of the fiber optic connector allows the end of the leaf spring conductor to enter the fiber optic connector, wherein each end of the leaf spring conductor contacts with a conductive backbone inside the fiber optic connector, and wherein the conductive backbone includes a first aperture to accept the electrical wire and a second aperture to let the optical fiber pass through.

According to another non-limiting exemplary embodiment of the present disclosure, a hybrid connector including an optical fiber component and an electrical conductor component is provided. This hybrid connector may contain an LC, CS, SN, FC, ST, MTP/MPO, or other type of fiber optic connector format and a corresponding fiber optic adapter, wherein the fiber optic connectors can be connected to each other via the fiber optic adapter, wherein a leaf spring conductor is located inside the fiber optic adapter, wherein an opening on top of the fiber optic connector allows the end of the leaf spring conductor to enter the fiber optic connector, wherein each end of the leaf spring conductor contacts with a conductive backbone inside the fiber optic connector, wherein the conductive backbone includes a first aperture to accept the electrical wire and a second aperture to let the optical fiber pass through.

A detailed description of this and other non-limiting exemplary embodiments of a hybrid connector and method for manufacturing and using such hybrid connector is set forth below together with the accompanying drawings.

### BRIEF DESCRIPTION OF THE DRAWINGS

FIG. 1 illustrates a perspective view of a hybrid connector assembly system, according to a non-limiting exemplary embodiment of the present disclosure.

FIG. 2 illustrates a perspective exploded view of the hybrid connector assembly system shown in FIG. 1, according to a non-limiting exemplary embodiment of the present disclosure.

FIG. 3 illustrates a perspective view of a hybrid connector included in the hybrid connector assembly system shown in FIG. 1, according to a non-limiting exemplary embodiment of the present disclosure.

FIG. 4 illustrates a perspective exploded view of the hybrid connector shown in FIG. 3, according to a non-limiting exemplary embodiment of the present disclosure.

FIG. 5A illustrates a perspective front-side view of an outer housing included in the hybrid connector shown in FIG. 3, according to a non-limiting exemplary embodiment of the present disclosure.

FIG. 5B illustrates a perspective rear-side view of the outer housing shown in FIG. 5A, according to a non-limiting exemplary embodiment of the present disclosure.

FIG. 6A illustrates a perspective front-side view of an inner housing included in the hybrid connector shown in FIG. 3, according to a non-limiting exemplary embodiment of the present disclosure.

FIG. 6B illustrates a perspective rear-side view of the inner housing shown in FIG. 6A, according to a non-limiting exemplary embodiment of the present disclosure.

FIG. 7A illustrates a top-down view looking down at a top-side of an inner housing included in the hybrid connector shown in FIG. 3, according to a non-limiting exemplary embodiment of the present disclosure.

FIG. 7B illustrates a side view of the inner housing shown in FIG. 7A, according to a non-limiting exemplary embodiment of the present disclosure.

FIG. 7C illustrates a head-on front-side view of the inner housing shown in FIG. 7A, according to a non-limiting exemplary embodiment of the present disclosure.

FIG. 8 illustrates a front-side perspective view of a backbone included in the hybrid connector shown in FIG. 3, according to a non-limiting exemplary embodiment of the present disclosure.

FIG. 9 illustrates a rear-side perspective view of a backbone included in the hybrid connector shown in FIG. 3, according to a non-limiting exemplary embodiment of the present disclosure.

FIG. 10A illustrates a front-side perspective view of a strain relief boot included in the hybrid connector shown in FIG. 3, according to a non-limiting exemplary embodiment of the present disclosure.

FIG. 10B illustrates a rear-side perspective view of the strain relief boot shown in FIG. 10A, according to a non-limiting exemplary embodiment of the present disclosure.

FIG. 11A illustrates a head-on front-side view of a strain relief boot included in the hybrid connector shown in FIG. 3, according to a non-limiting exemplary embodiment of the present disclosure.

FIG. 11B illustrates a top-down view looking down at a top-side of the strain relief boot shown in FIG. 11A, according to a non-limiting exemplary embodiment of the present disclosure.

FIG. 12 illustrates a perspective view of a connector adapter included in the hybrid connector assembly system shown in FIG. 1, according to a non-limiting exemplary embodiment of the present disclosure.

FIG. 13 illustrates a perspective exploded view showing internal components of a connector adapter included in the hybrid connector assembly system shown in FIG. 1, according to a non-limiting exemplary embodiment of the present disclosure.

FIG. 14A illustrates a perspective front-side view of an adapter latch housing included in the connector adapter shown in FIG. 13, according to a non-limiting exemplary embodiment of the present disclosure.

FIG. 14B illustrates a perspective rear-side view of the adapter latch housing shown in FIG. 14A, according to a non-limiting exemplary embodiment of the present disclosure.

FIG. 15A illustrates a top-down view looking down at a top of an adapter latch housing included in the connector adapter shown in FIG. 13, according to a non-limiting exemplary embodiment of the present disclosure.

FIG. 15B illustrates a sectional view taken along a section line from the adapter latch housing shown in FIG. 15A, according to a non-limiting exemplary embodiment of the present disclosure.

FIG. 15C illustrates a head-on front-side view of the adapter latch housing shown in FIG. 15A, according to a non-limiting exemplary embodiment of the present disclosure.

FIG. 16A illustrates a perspective front-side view of an adapter housing included in the connector adapter shown in FIG. 13, according to a non-limiting exemplary embodiment of the present disclosure.

FIG. 16B illustrates a perspective rear-side view of the adapter housing shown in FIG. 16A, according to a non-limiting exemplary embodiment of the present disclosure.

FIG. 17A illustrates a top-down view looking down at a top of an adapter housing included in the connector adapter shown in FIG. 13, according to a non-limiting exemplary embodiment of the present disclosure.

FIG. 17B illustrates a sectional view taken along a section line from the adapter housing shown in FIG. 17A, according to a non-limiting exemplary embodiment of the present disclosure.

FIG. 17C illustrates a head-on front-side view of the adapter latch housing shown in FIG. 15A, according to a non-limiting exemplary embodiment of the present disclosure.

FIG. 18A illustrates a perspective front-side view of a connector latch included in the adapter latch housing shown in FIG. 14A, according to a non-limiting exemplary embodiment of the present disclosure.

FIG. 18B illustrates a perspective rear-side view of a connector latch included in the adapter latch housing shown in FIG. 14A, according to a non-limiting exemplary embodiment of the present disclosure.

FIG. 19A illustrates a perspective view of a leaf spring contact included in the connector adapter shown in FIG. 13, according to a non-limiting exemplary embodiment of the present disclosure.

FIG. 19B illustrates a side view of the leaf spring contact shown in FIG. 19A, where the leaf spring contact is in an uninstalled state, according to a non-limiting exemplary embodiment of the present disclosure.

FIG. 19C illustrates a side view of the leaf spring contact shown in FIG. 19A, where the leaf spring contact is in a partially installed state, according to a non-limiting exemplary embodiment of the present disclosure.

FIG. 19D illustrates a side view of the leaf spring contact shown in FIG. 19A, where the leaf spring contact is in an installed state, according to a non-limiting exemplary embodiment of the present disclosure.

FIG. 20 illustrates a side view of the hybrid connector assembly system shown in FIG. 1, according to a non-limiting exemplary embodiment of the present disclosure.

FIG. 21 illustrates a sectional view taken along a sectional line of the hybrid connector assembly shown in FIG. 20, according to a non-limiting exemplary embodiment of the present disclosure.

### DETAILED DESCRIPTION

Detailed non-limiting embodiments of a hybrid connector assembly are disclosed herein. However, it is to be understood that the disclosed embodiments are merely exemplary and may take various and alternative forms. The figures are not necessarily to scale, and features may be exaggerated or minimized to show details of particular components. Therefore, specific structural and functional details disclosed herein are not to be interpreted as limiting, but merely as a representative basis for teaching one skilled in the art.

Described herein is a novel hybrid connector assembly system that includes both a hybrid connector and hybrid connector adapter. The hybrid connector assembly system is able to couple with hybrid cables (e.g., cables including both optical fiber and electrical conductor wires) to enable the transmission of both fiber optic data transmission as well as power, and/or data, transmission over the conductor wires. The hybrid connector may be formed within the same form factor of existing fiber connectors (e.g., LC, SC, MPO, or other known existing fiber connector formats) to remove, or at least minimize, the need for updating existing installations. In other words, the hybrid connector and hybrid connector adapters may be retrofitted into existing fiber connection systems with minimal efforts. Therefore, the hybrid connector assembly system provides an efficient and effective solution for providing both optical data and power transmission with a single connector.

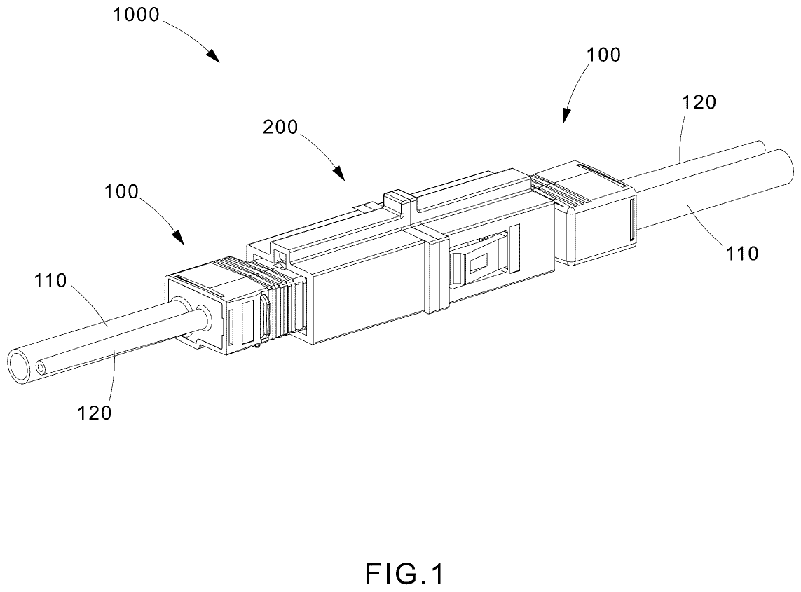

FIG. 1 shows an exemplary hybrid connector assembly system 1000 that includes one fiber optic circuit for transmitting data over an optical fiber, and one electrical circuit for transmitting power over a conductor wire (e.g., copper wire). This description is provided with reference to the known SC connector and adapter format, although the solutions and features described herein may be applied to other fiber connector formats (e.g., LC, MPO, SN, CS, or the like). The hybrid connector assembly system 1000 includes a connector adaptor 200 that, like a conventional SC adapter, can be installed in a standard-sized patch panel or cassette module. The hybrid connector assembly system 1000 also includes a hybrid connector 100 for installing into one side of the connector adapter 200, and another hybrid connector 100 for installing into the opposite side of the connector adapter 200. The two hybrid connectors 100 installed into the two opposite sides of the connector adapter 200 are the same, as will be described in more detail below. For each hybrid connector 100, a first cylindrical section 110 is included for holding a conductor wire, and a second cylindrical section 120 is also included for holding an optical fiber. The conductor wire and the optical fiber may be included in a same hybrid cable, as will be described in more detail herein.

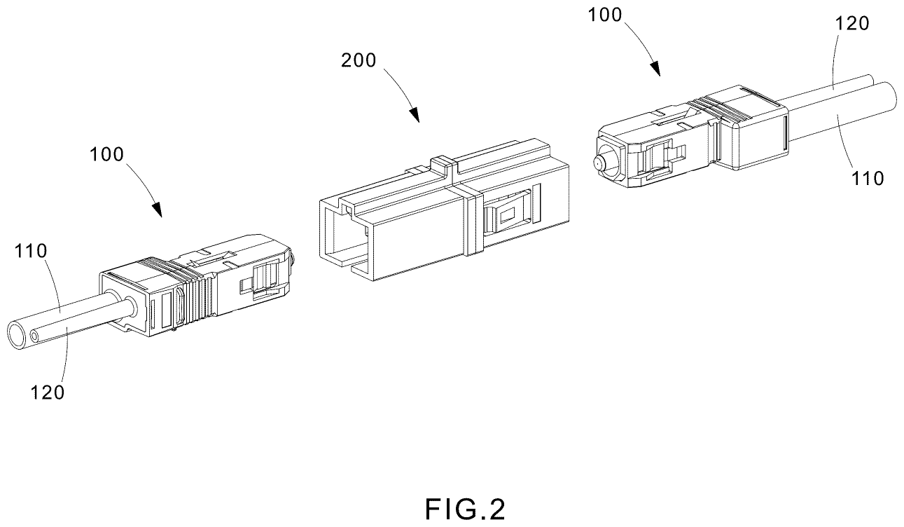

FIG. 2 shows the hybrid connector assembly system 1000 in an exploded view to show how the hybrid connectors 100 are installed into the connector adaptor 200, as well as to show certain internal components of the connector adaptor 200.

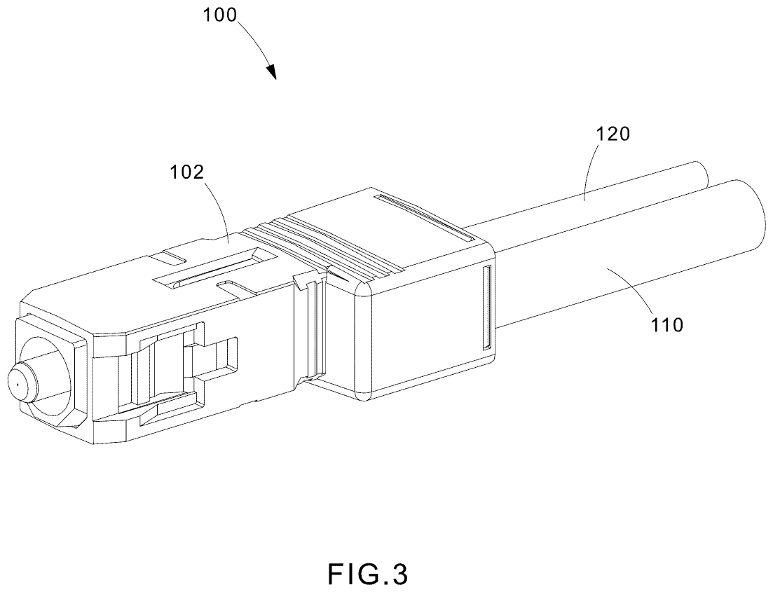

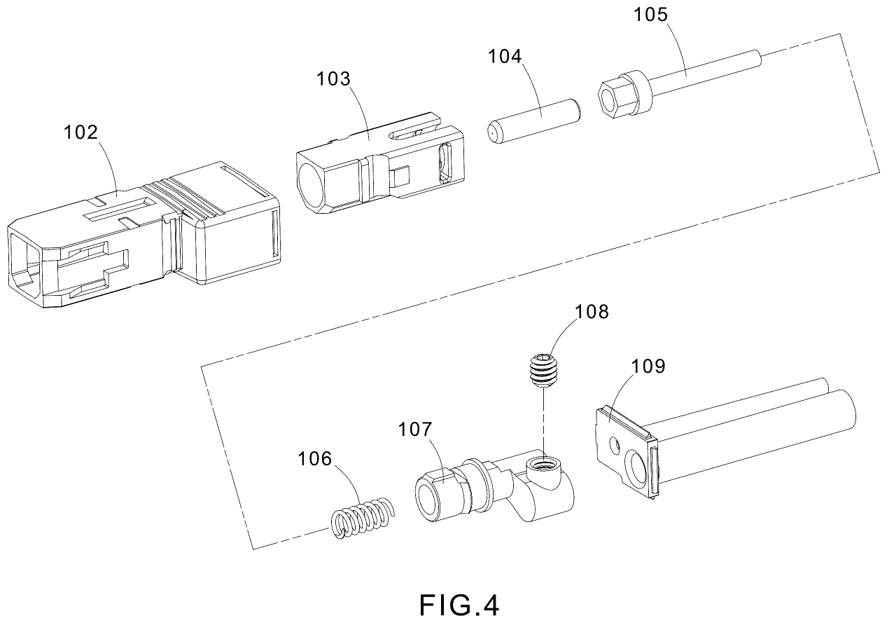

FIG. 3 shows a perspective view of the hybrid connector 100 in an assembled state. FIG. 4 shows an exploded view of the hybrid connector 100 that better shows certain internal components of the hybrid connector 100. The hybrid connector 100 is shown to include an outer housing 102, an inner housing 103, a ferrule 104, a ferrule holder 105, a coil spring 106, a conductive backbone 107, a set screw 108, and a strain relief boot 109.

The design of the conductive backbone 107 to include a first opening for accepting a conductive wire and a second opening for receiving the set screw 108 may be a new design not found in conventional fiber only connectors, as the set screw 108 is used to clamp down on the conductive wire of a hybrid cable coupled to the hybrid connecter 100, as will be describe in more detail herein.

The ferrule 104, ferrule holder 105, and coil spring 106 may exist in conventional fiber connectors without much change as they are simply responsible for the transmission of the data over optical fiber.

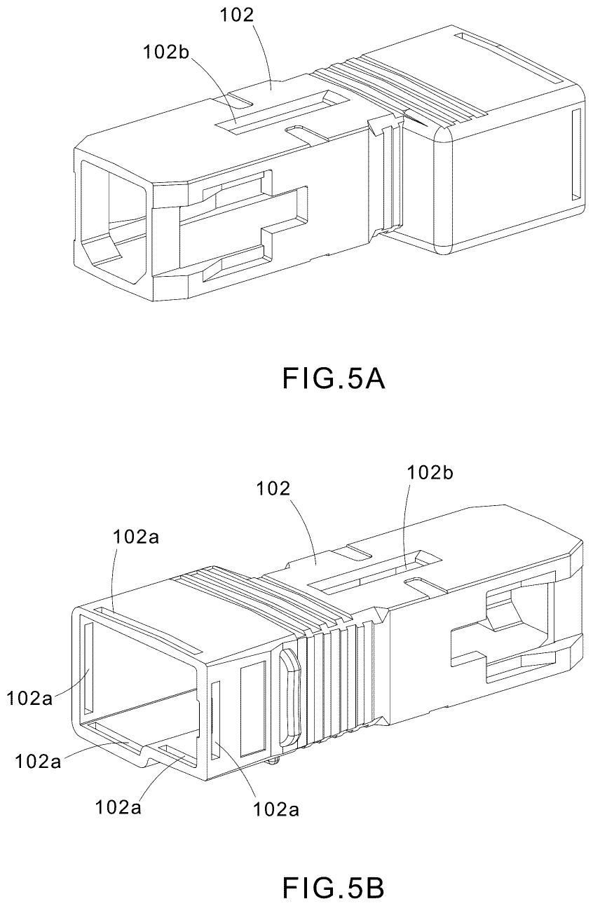

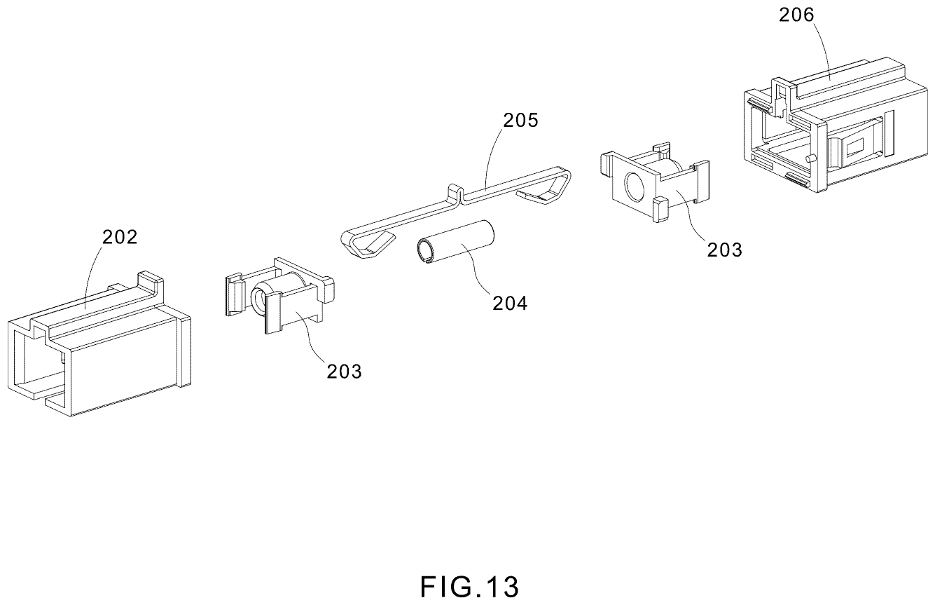

A rear profile of the outer housing 102 is enlarged to accommodate the conductive backbone 107, which is larger than a backbone found on a conventional fiber connector that does not enable power transmission via a conductive wire. As shown in FIG. 5A, a large rectangular opening feature 102b is added to the top of the outer housing 102 to allow a leaf spring contact 205 of the connector adapter 200 to pass through the outer housing 102 portions of the hybrid connecter 100. This large rectangular opening feature 102b is large enough to enable the leaf spring contact 205 to pass through to make contact with the conductive backbone 107, but also small enough to keep the hybrid connector 100 electrically finger touch safe. The two ends of the large rectangular opening feature 102b are each chamfered away from the center of the part. These chamfer features are intended to help allow leaf spring contact 205 to ramp in and out of the large rectangular opening feature 102b. The outer housing may have a length of 1.090″ which is an increase from analogous conventional fiber connectors to compensate for the increased length of the connector adapter 200, where the connector adapter includes an adapter housing 202 and an adapter latch housing as shown in FIG. 13. The increased length is a feature to ensure adequate finger access when the hybrid connector 100 is installed in the connector adapter 200. Finger access may be utilized to install and remove the hybrid connector 100.

As shown in FIG. 5B, a plurality of rectangular openings 102a (e.g., five rectangular openings) are added to a perimeter of a rear opening of the outer housing 102 to accommodate the strain relief boot 109 design, where the strain relief boot 109 design is unique to accommodate coupling to a hybrid cable including both an optical fiber and a conductive wire.

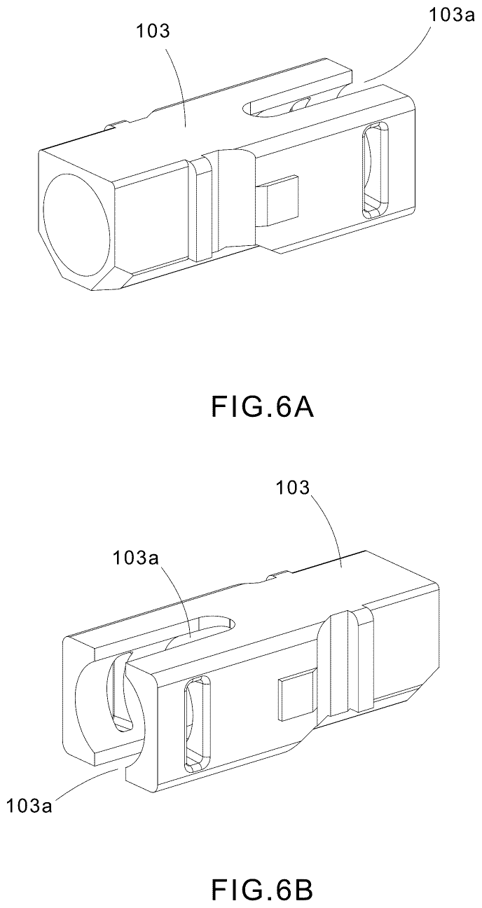

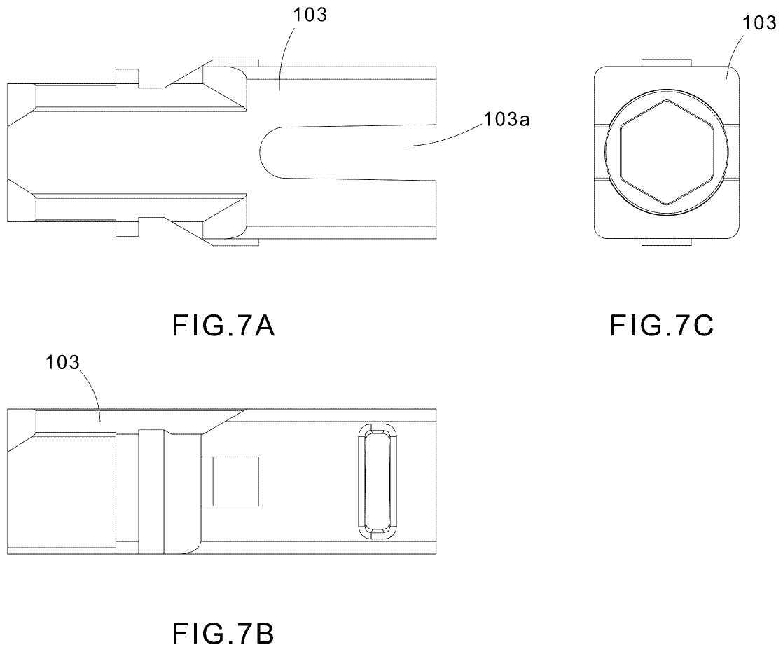

FIGS. 6A-6B and 7A-7C show various views of the inner housing 103. The inner housing 103 includes two oval slots 103a on opposite sides of the inner housing 103, where these oval slots 103a are enlarged to allow adequate space for the leaf spring contact 205 to pass through the inner housing 103 portions of the hybrid connector 100. The leaf spring contact 205 has a minimum cross-sectional area required to allow sufficient current to pass through it. To achieve this, the width of the leaf spring contact 205 is greater than a width of the oval slots 103a that may be found on analogous conventional fiber connectors. For this reason, the oval slots 103a on the inner housing 103 are both widened and lengthened when compared to analogous features on conventional fiber connectors.

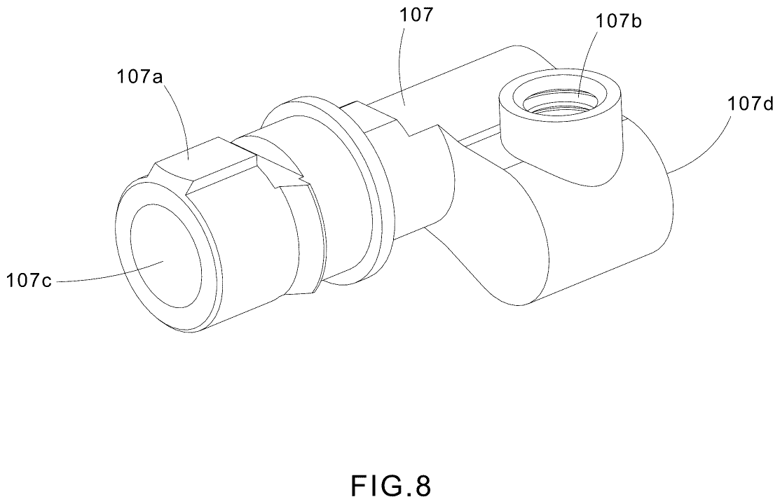

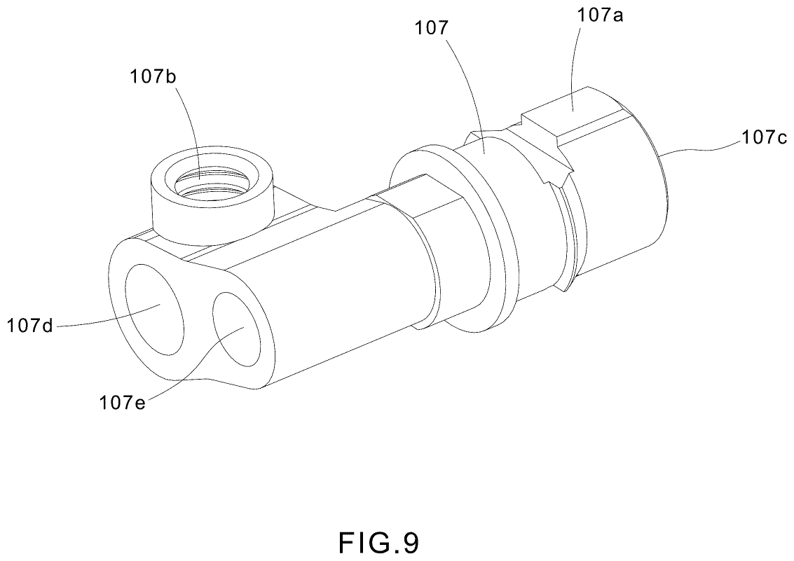

FIGS. 8 and 9 show views of the conductive backbone 107 described earlier as being included as an internal component of the hybrid connector 100. The geometry on the rear of the conductive backbone 107 is revised and enlarged, when compared to a component of an analogous fiber connector, to accommodate the installation of a conductor wire in addition to an optical fiber from a hybrid cable, where the conductor wire has a larger diameter compared to the optical fiber (e.g., conductor wires may be at least 16 AWG in diameter). The geometry now includes a first opening 107d at a rear-side of the conductive backbone 107 that opens to a first cylindrical channel for accepting and housing the conductor wire. The geometry also includes a second cylindrical channel within the conductive backbone 107 that extends from a second opening 107e at the rear-side of the conductive backbone 107 to a third opening 107c located at a front-side of the conductive backbone 107, where the second channel is configured to enable the optical fiber to pass through the length of the conductive backbone 107. The conductive backbone 107 also includes a threaded cylindrical hole 107b configured to accept the set screw 108. The first opening 107d, and the corresponding first cylindrical channel, is larger in diameter from the second opening 107e and the third opening 107c, corresponding to the second cylindrical channel, as the first opening 107d is configured to accept the larger diameter conductor wire (e.g., 16 AWG or thicker). Alternatively, instead of the set screw 108 for anchoring in the conductor wire, the conductor wire may be secured to the first cylindrical channel using a spring-loaded connection or a push-in wire connection.

The conductive backbone 107 also includes a rectangular flat section 107a that is added to the front of the conductive backbone 107 to promote good physical contact with leaf spring contact 205. This contact between the conductive backbone 107 and the leaf spring contact 205 provides electrical continuity from the hybrid connector 100 and through the connector adapter 200. A ribbing typically found on the rear of an analogous part of a conventional connector that is used to retain a conventional strain relief boot is removed from this conductive backbone 107 included in the hybrid connector 100. This conductive backbone 107 may be made from a good conductive material that is still sufficiently strong but is a better conductor of electricity, such as copper. This is compared to a conductive backbone that may be made from stainless steel in the conventional fiber connector, which is not a good conductor of electricity.

The set screw 108 is added to the conductive backbone 107 to retain the larger gauge conductive wire from the hybrid cable within the barrel of conductive backbone 107. The set screw 108 also creates a normal force between the conductive wire and the conductive backbone 107, thus promoting high electrical conductivity. The set screw 108 also allows for easy field termination. The set screw 108 may have 4-40 UNC threads and be ⅛″ in length, and can be made from a readily available material, such as steel or stainless steel.

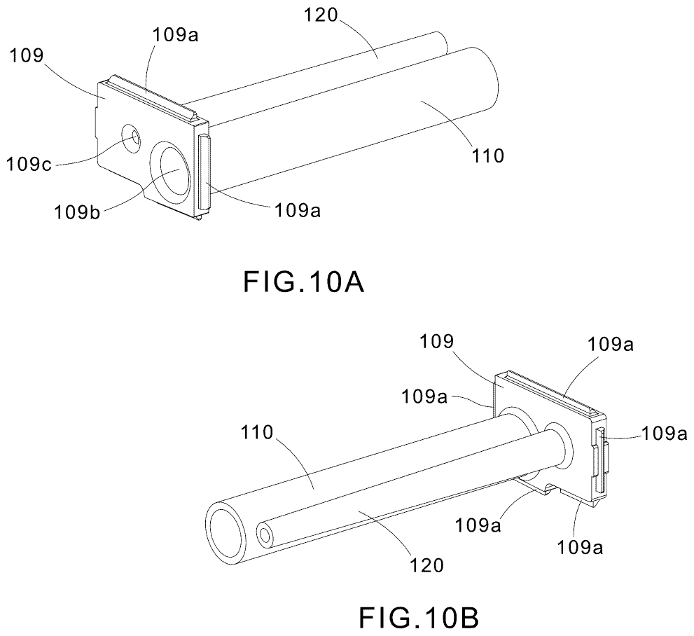

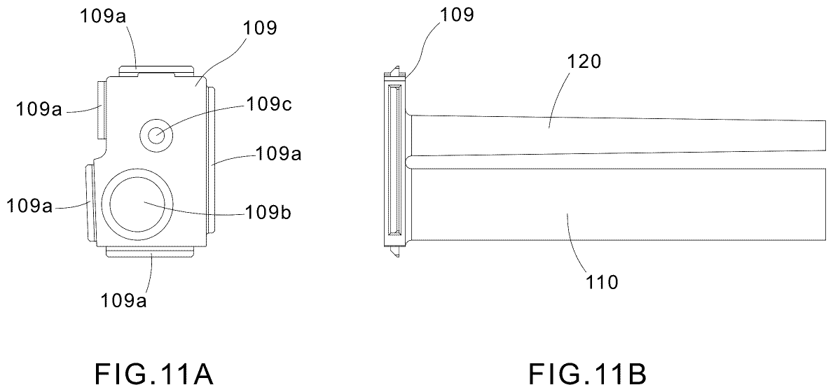

FIGS. 10A-10B and 11A-11B show various views of the strain relief boot 109. The geometry of the strain relief boot 109 is entirely revised from an analogous part in the conventional fiber connector. The present strain relief boot 109 now includes the first cylindrical section 110 for holding the conductor wire of the hybrid cable, and the second cylindrical section 120 to accommodate the optical fiber of the hybrid cable. To accommodate the comparative sizes of the conductor wire and the optical fiber they will be holding, the first cylindrical section 110 may have a larger diameter compared to the second cylindrical section 120. Although according to other embodiments, the first cylindrical section 110 may have a smaller, or same, diameter compared to the second cylindrical section 120 based on a gauge of the conductor wire in the hybrid cable being supported by the first cylindrical section 110 and/or number of optical fibers in the hybrid cable being supported by the second cylindrical section 120.

The strain relief boot 109 also includes a first opening 109b for receiving the conductive wire into the first cylindrical section 110, and a second opening 109c for receiving the optical fiber into the second cylindrical section 120. The second cylindrical section 120 may have a more tapered shape compared to the first cylindrical section 110, as seen in FIG. 11B. According to alternative embodiments, one, or both, the first cylindrical section 110 and the second cylindrical section 120 may have a tapered shape. According to alternative embodiments, one, or both, the first cylindrical section 110 and the second cylindrical section 120 may have a straight cylindrical shape.

The present strain relief boot 109 has also been revised to fasten to the outer housing 102 instead of the conductive backbone 107, as in the conventional fiber connector design. To achieve this, the strain relief boot 109 includes five barb-like features 109a to mate with the five rectangular openings 102a in the outer housing 102. These barb-like features 109a are intended to retain the strain relief boot 109 within the outer housing 102. This revised design for the strain relief boot 109 eliminates openings or gaps in the rear of outer housing 102 to create an electrically touch-safe hybrid connector 100.

In addition, this revised design of the strain relief boot 109 also has optical performance benefits. For example, if the strain relief boot 109 were attached to the conductive backbone 107 instead of the outer housing 102, any radial force placed on the strain relief boot 109 will have the propensity to transfer the force to the ferrule holder 105. This, in turn, would create a misalignment between the two ferrule 104 end faces, resulting in optical performance loss. So, by instead having the strain relief boot 109 attach directly to the outer housing 102, this provides a much stronger and secure attachment coupling that significantly reduces the amount of radial force being transferred onto the ferrule holder 105 for causing undesirable misalignment issues. The material of the first cylindrical section 110 and the second cylindrical section 120 may be silicone or another type of rubber, such as EPDM.

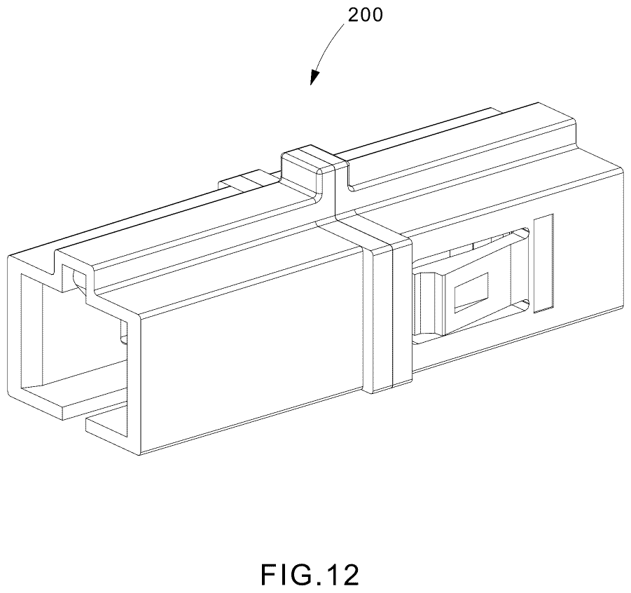

The revised design of the present connector adapter 200 is shown in FIG. 12, where the connector adapter 200 includes an adapter housing 202 and an adapter latch housing 206. FIG. 13 further shows an exploded view of the connector adapter that displays additional internal components such as a connector latch 203 included in the adapter housing 202, a connector latch 203 included in the adapter latch housing 206, a split sleeve 204 inserted between the connector latch 203 in the adapter housing 202 and the connector latch 203 in the adapter latch housing 206, and the leaf spring contact 205 that has been described previously.

The leaf spring contact 205 is a component added to the present connector adapter 200 that may not be included in other conventional connector adapters. A total length of the connector adapter 200 may be 1.48 inches, making it approximately 0.4 inches longer than a conventional analogous connector adapter (e.g., SC adapter). The adapter housing 202 and adapter latch housing 206 are lengthened to help keep the system electrically touch-safe.

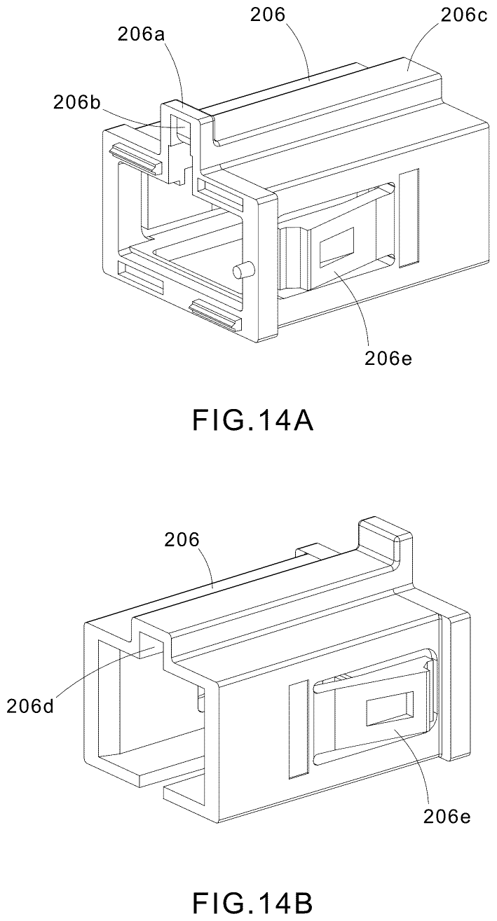

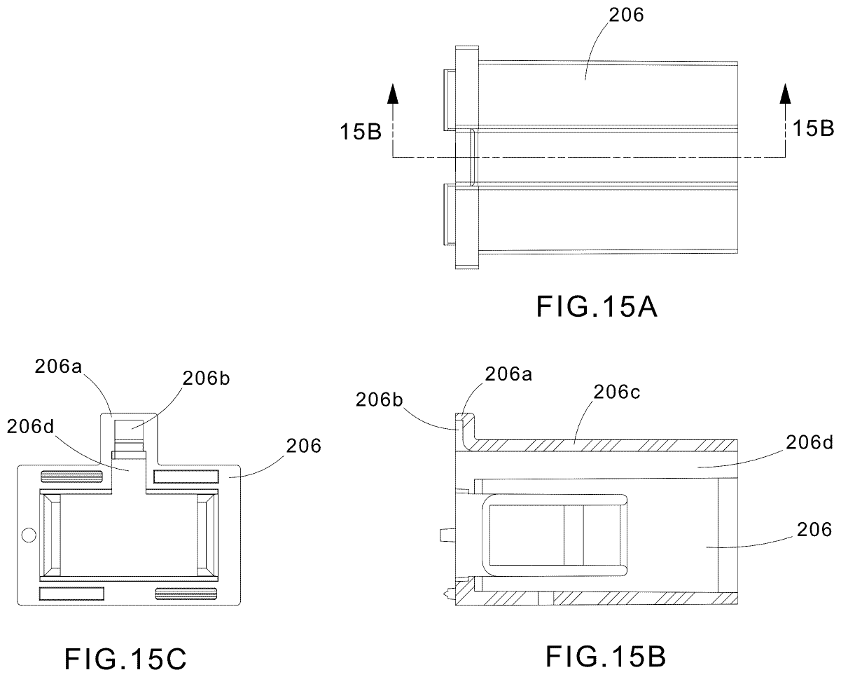

FIGS. 14A and 14B show a perspective front-side view and a perspective rear-side view, respectively, of the adapter latch housing 206. The adapter latch housing 206 includes latch protrusions 206e on opposite side walls. The top of the adapter latch housing 206 includes a leaf spring channel 206c, that forms an internal channel 206d for housing the leaf spring contact 205. The front-side of the adapter latch housing 206 includes a tall tab 206a and a rectangular pocket 206b. The purpose of the tall tab 206a and the rectangular pocket 206b is to attach/interact with corresponding features on the adapter housing 202 to retain the leaf spring contact 205 between the two parts via friction when assembled via gluing or ultrasonic welding. FIG. 15A shows a top-down view of the adapter latch housing 206, and FIG. 15B shows a sectional view of the adapter latch housing 206 along a line 15B-15B shown in FIG. 15A. FIG. 15C shows a head-on front-side view of the adapter latch housing 206.

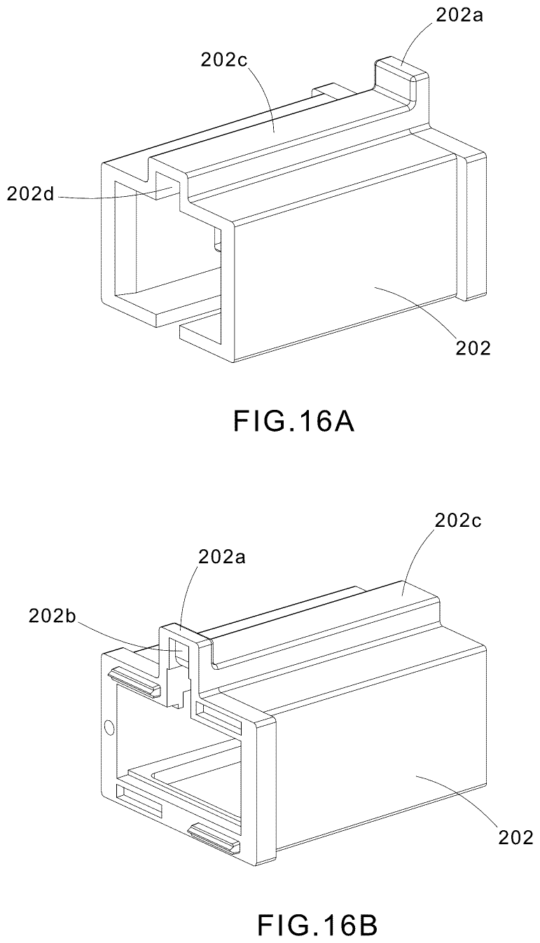

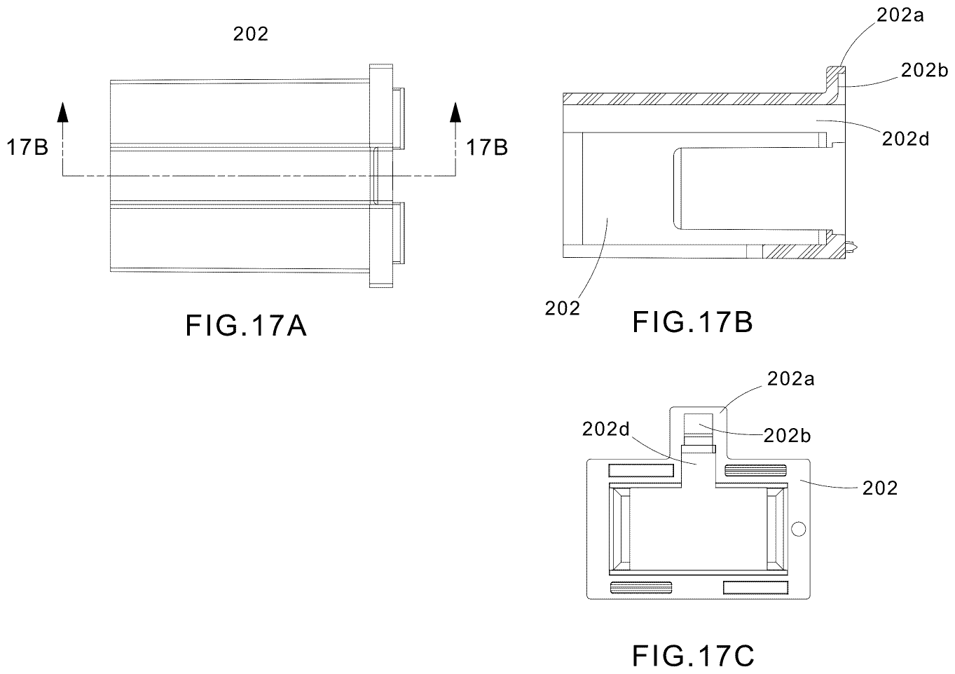

FIGS. 16A and 16B show a perspective front-side view and a perspective rear-side view, respectively, of the adapter housing 202. The adapter housing 202 includes latch protrusions 202e on opposite side walls. The top of the adapter housing 202 includes a leaf spring channel 202c, that forms an internal channel 202d for housing the leaf spring contact 205. The front-side of the adapter housing 202 includes a tall tab 202a and a rectangular pocket 202b. The purpose of the tall tab 202a and the rectangular pocket 202b is to attach/interact with corresponding features on the adapter latch housing 206 to retain the leaf spring contact 205 between the two parts via friction when assembled via gluing or ultrasonic welding. FIG. 17A shows a top-down view of the adapter housing 202, and FIG. 17B shows a sectional view of the adapter housing 202 along a line 17B-17B shown in FIG. 17A. FIG. 17C shows a head-on front-side view of the adapter housing 202.

To create the electrical connection between the conductive backbone 107 and the leaf spring contact 205, the connector adapter 200 dictates physical contact between the adapter housing 202 and the adapter latch housing 206 near the front of the conductive backbone 107. In conventional fiber connector designs, when the conventional fiber connector is connected to its connector adapter, this location is just outside the semi-enclosed area created by an adapter housing 202 and/or adapter latch housing 206. Without lengthening both parts, the leaf spring contact 205 would extend into free air, creating an electrically unsafe touch condition. So, to address this shortfall, several new features can be found in both the adapter housing 202 and the adapter latch housing 206. The first feature is the internal channels 202d, 206d that semi-encloses the length of the leaf spring contact 205. In addition to housing the leaf spring contact 205, the internal channels 202d, 206d also provide space for the leaf spring contact 205 to displace/compress when the hybrid connector 100 is inserted into either of the insertion openings in the connector adapter 200. The second feature is the tall tabs 202a, 206a and the rectangular pockets 202b, 206b near the front of the adapter housing 202 and the adapter latch housing 206. Part alignment tabs are also relocated to accommodate the rectangular pockets 202b, 206b. The purpose of the rectangular pockets 202b, 206b is to retain the leaf spring contact 205 between the adapter housing 202 and the adapter latch housing 206 via friction when assembled via gluing or ultrasonic welding. Both the adapter housing 202 and the adapter latch housing 206 can be made from flame-retardant polycarbonate.

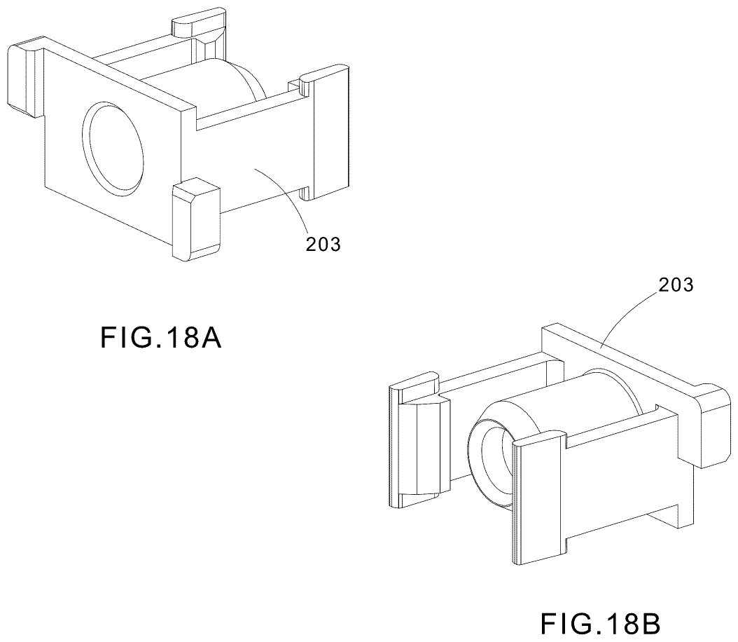

FIGS. 18A and 18B show a perspective view of a connector latch 203 included in the adapter latch housing 206, and a connector latch 203 included in the adapter housing 202.

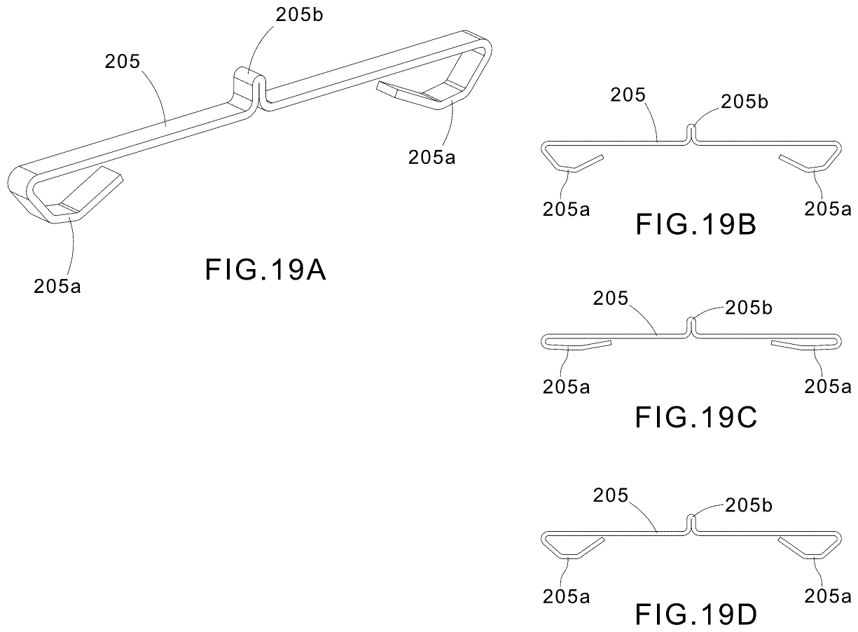

FIG. 19A shows a perspective view of the leaf spring contact 205, where the leaf spring contact 205 is shown to include spring loop sections 205a at either opposite ends, a vertical hemmed section 205b rising up from a middle portion, where the spring loop sections 205a include flat sections at their apex tips.

FIGS. 19B to 19D show the leaf spring contact 205 in various states of installation. For example, FIG. 19B shows the leaf spring contact 205 as it would be formed during an uninstalled state where the hybrid connectors 100 have not been installed into the connector adapter 200 and therefore are not placing any deforming force onto the spring loops 205a, FIG. 19C shows the leaf spring contact 205 as it would be formed during a partially installed state where the hybrid connectors 100 have been partially installed into the connector adapter 200 and are placing the greatest amount of deforming force onto the spring loops 205a, and FIG. 19D shows the leaf spring contact 205 as it would be formed during a fully installed state where the hybrid connectors 100 have been fully installed into the connector adapter 200 and are placing an adequate amount of deforming force onto the spring loops 205a enough to create a holding force between conducting portions of the installed hybrid connectors 100.

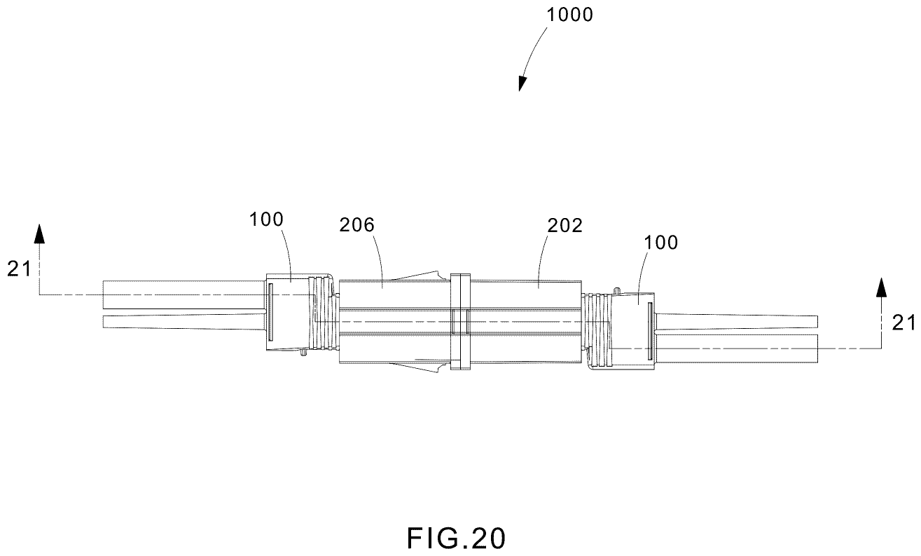

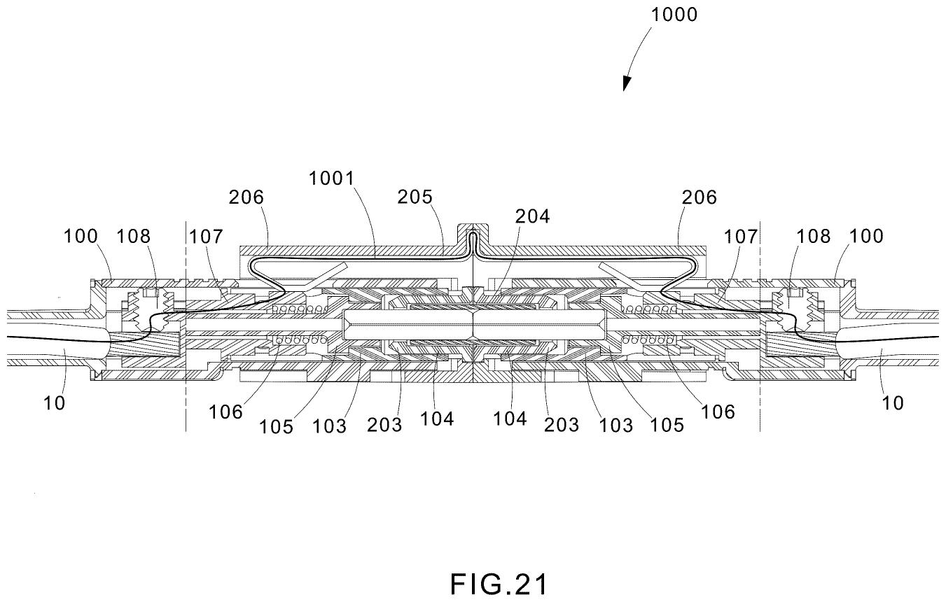

The leaf spring contact 205 is configured to facilitate electrical conductivity between two mated hybrid connectors 100 that have been installed into the connector adapter 200. The electrical conductivity path 1001 through the whole hybrid connector assembly system 1000 can be seen in FIG. 21, where FIG. 21 shows a sectional view of the hybrid connector assembly system 1000 show in FIG. 20 taken along a sectional line 20-20. The leaf spring contact 205 geometry is symmetrical about the front and right planes. The flat sections of the spring loops 205a are configured to make physical contact with the conductive backbone 107 when the hybrid connectors 100 are installed into the connector adapter 200. This conducting connection point provides electrical conductivity between the hybrid connector 100 and the connector adapter 200, which in turn further provides continuous electrical conductivity with the hybrid connector 100 installed at the opposite end of the connector adapter 200.

The flat section in the spring loops 205a ensure a large contact area with the conductive backbone 107 included in the two installed hybrid connectors 100. The geometry of the spring loops 205a is designed to provide a normal force on the front flat section of the conductive backbone 107 when the hybrid connector 100 is inserted into the connector adapter 200. Both the flat section and the normal force decrease the electrical contact resistance between these two parts. The geometry of the spring loops 205a is also designed in a ramped manner that allows for easy insertion and removal of the hybrid connector 100 into and out of the connector adapter 200. The portions of the spring loops 205a nearest to the openings (i.e., the connector insertion sides) in the adapter housing 202 and/or the adapter latch housing 206, are sloped/ramped in a direction away from these openings. The front of the hybrid connector 100 makes physical contact with this sloped/ramped section upon insertion into the connector adapter 200. In turn, the geometry of the spring loops 205a compresses/displaces into the rectangular pockets 202b, 206b of the adapter housing 202 and/or the adapter latch housing 206.

The portions of the spring loops 205a that are farthest from the openings in the adapter housing 202 and/or the adapter latch housing 206 are sloped/ramped in a direction toward these openings. The front chamfered portion of the opening in the top of outer housing 102 makes physical contact with this portion of the spring loops 205a upon removal of the hybrid connector 100 from the connector adapter 200. This contact displaces the spring loops 205a into the rectangular pockets 202b, 206b of the adapter housing 202 and/or the adapter latch housing 206, which allows the hybrid connector 100 to be removed from the connector adapter 200. The cross-sectional area of the entire leaf spring contact 205 is similar to that of the conductor wire included in the hybrid cable (e.g., a 16 AWG conductor wire). Because of this, the hybrid connector assembly system 1000 has the capability to carry power and current that is similar in magnitude to the capabilities of a 16 AWG wire, as illustrated by the exemplary conductivity path 1001 shown in FIG. 21. The material of the leaf spring contact may be beryllium copper (spring copper). This material allows the mechanical spring action needed to insert and remove the hybrid connector 100 into and out of the connector adapter 200. It is also a great electrical conductor and promotes high power and current-carrying capability throughout this system.

As is readily apparent from the foregoing, various non-limiting exemplary embodiments of a hybrid connector assembly system have been described. While various embodiments have been illustrated and described herein, they are exemplary only and it is not intended that these embodiments illustrate and describe all those possible. Instead, the words used herein are words of description rather than limitation, and it is understood that various changes may be made to these embodiments without departing from the spirit and scope of the following claims.

What is claimed is:

1. A hybrid connector assembly system, the system comprising:
a first hybrid connector including a first housing, the first housing configured to hold a first fiber ferrule and a first conductive backbone;
a second hybrid connector including second housing, the second housing configured to hold a second fiber ferrule and a second conductive backbone; and
a hybrid adapter including a leaf spring conductor, wherein when the first hybrid connector and the second hybrid connector are installed into the hybrid adapter, the first hybrid connector and the second hybrid connector are coupled to each other via an electrical coupling between the leaf spring conductor and the first conductive backbone and the second conductive backbone.

2. The hybrid connector assembly system of claim 1, the first housing further comprising a first top opening and the second housing further comprising a second top opening;
wherein when the first hybrid connector and the second hybrid connector are installed into the hybrid adapter, the leaf spring conductor is configured to contact the first conductive backbone through the first top opening and the leaf spring conductor is configured to contact the second conductive backbone through the second top opening.

3. The hybrid connector assembly system of claim 1, the first conductive backbone further comprising:
a channel through which an optical fiber is configured to be routed through; and
an aperture configured to accept a conductor wire.

4. The hybrid connector assembly system of claim 3, the first conductive backbone further comprising:
a threaded cylindrical aperture configured to accept a set screw that, when rotated down the threaded cylindrical aperture, anchors against the conductor wire within the aperture.

5. The hybrid connector assembly system of claim 1, wherein the leaf spring conductor includes a first spring loop at a first end and a second spring loop at a second end.

6. The hybrid connector assembly system of claim 1, wherein the hybrid adapter is comprised of a first half adapter and a second half adapter, wherein at least a portion of the leaf spring conductor is installed within both the first half adapter and the second half adapter.

7. The hybrid connector assembly system of claim 1, wherein the first hybrid connector is configured to include one of an LC, CS, MPO, SN, SC, or ST fiber connector form factor.

8. The hybrid connector assembly system of claim 1, the first hybrid connector further comprising a boot including a first cylindrical section and a second cylindrical section, wherein the first cylindrical section is configured to hold at least a portion of a conductor wire and the second cylindrical section is configured to hold at least a portion of an optical fiber.

9. A hybrid connector comprising:
a housing including a top opening;
a fiber ferrule coupled to an optical fiber; and
a conductive backbone positioned within the housing and coupled to a conductor wire, the conductive backbone configured to couple with a leaf spring conductor included in a hybrid adapter when the hybrid connector is installed into the hybrid adapter.

10. The hybrid connector of claim 9, wherein the leaf spring conductor is configured to contact the conductive backbone through the top opening.

11. The hybrid connector of claim 9, the conductive backbone further comprising:
a channel through which the optical fiber is configured to be routed through; and
an aperture configured to accept the conductor wire.

12. The hybrid connector of claim 11, the conductive backbone further comprising:
a threaded cylindrical aperture configured to accept a set screw that, when rotated down the threaded cylindrical aperture, anchors against the conductor wire within the aperture.

13. The hybrid connector of claim 9, wherein the leaf spring conductor includes a first spring loop at a first end and a second spring loop at a second end.

14. The hybrid connector of claim 9, wherein the hybrid adapter is comprised of a first half adapter and a second half adapter, wherein at least a portion of the leaf spring conductor is installed within both the first half adapter and the second half adapter.

15. The hybrid connector of claim 9, wherein the hybrid connector is configured to include one of an LC, CS, MPO, SN, SC, or ST fiber connector form factor.

16. The hybrid connector of claim 9, the hybrid connector further comprising:
a boot including a first cylindrical section and a second cylindrical section, wherein the first cylindrical section is configured to hold at least a portion of the conductor wire and the second cylindrical section is configured to hold at least a portion of the optical fiber.
